(19) United States
(12) Patent Application Publication
(10) Pub. No.: US 2007/0059468 A1
(43) Pub. Date: Mar. 15, 2007

(54) Graft coating for pre-insulated pipe

(76) Inventors: Kim S. Kirkegaard, Aalborg (DK); Lars Bo Hansen, Logstor (DK)

Correspondence Address: WOLF BLOCK SCHORR AND SOLIS-COHEN LLP, 250 PARK AVENUE, NEW YORK, NY, 10177, US

(21) Appl. No.: 11/222,637

(22) Filed: Sep. 9, 2005

(51) Int. Cl. B32B 1/08

(52) U.S. Cl. 428/36.91

(57) ABSTRACT

A graft coated pre-insulated pipe with fire retardant properties including a graft coating applied to the exterior of a pre-insulated pipe. The graft coating includes a graft solution and an expandable insulation material. The invention prevents damage to pre-insulated pipes caused by the expansion of the gasses in the cells of the foam within the pre-insulated pipe as a result of exposure to heat.

### FIELD OF THE INVENTION

The present invention relates generally to products and methods in the field of pre-insulated pipes, and more particularly, to a graft coated pre-insulated pipe with flame retardant properties and methods of manufacturing the aforementioned product.

### BACKGROUND OF THE INVENTION

Polyethylene (“PE”) has many desirable mechanical properties and it is readily synthesized, and manufactured in any desired shape and size. In particular, there are many uses for PE, in its several grades, and particularly for high density polyethylene (“HDPE”) in the form of tubing, pipes, conduits, and the like. For ease of reference, the use of the term, “pipe” or “piping” in the singular or plural herein, should be understood to also encompass any other configuration of tubing or conduit, and the joiner and/or connector components, such as straight joints, elbow joints, end-caps and the like, unless otherwise specified.

It is also known in the art that many potential uses for pipe comprising PE, in whole or in part, have previously been impractical due to the inherent limitations of this polymer material. This is of particular concern in the manufacture of extruded, pre-insulated pipes for general industry, the building trades, ocean platforms, e.g., offshore oil and gas platforms, and ship building. In all of those environments, there is a demand for pre or traditional insulated pipes. Generally, pipes that are pre-insulated during the manufacturing process are more economical to produce and install. One preferred type of pre-insulated pipe has an inner carrier pipe, manufactured from any art-known material such as, for example, mild steel, stainless steel, PE formulated with any art-known copolymer (“PEX”) and/or HDPE, and the like. This inner carrier pipe is jacketed with a foam insulating layer, e.g., a hard polyurethane foam, that is, in turn, encased by a protective outer shell, preferably of HDPE, although steel is used for some applications. Optionally, one or more additional layers of foam, or other insulating materials, e.g., mineral wool or fiberglass or similar material, can also be incorporated into the structure of such insulated pipe. This type of pipe, with an HDPE outer shell, is typically manufactured as a single unit by either a traditional extrusion process or as a continuous process where insulation material and casing material are applied in one process (or operation).

HDPE pipes, including insulated pipes with an HDPE outer shell, are economical to manufacture and install, light, strong, and corrosion resistant. Of particular importance for the ship-building industry, pre-insulated pipes encased with HDPE pipe are more resistant to penetration of moisture into the insulating layer than are conventional insulated pipes. However, there are obstacles to wider use of this type of pre-insulated pipe manufactured solely from polymer materials. The most important obstacle is that pre-insulated pipes manufactured with conventional PE-based polymers, including HDPE, are generally unsuitable for use in areas where flame retardancy is required. For example, the melting point for HDPE is about 120° C. When exposed to sufficient heat for even a brief period of time, HDPE readily melts and forms burning drops which can spread fire and/or cause severe burns on contact with human skin and clothing. Once ignited, HDPE burns intensely, producing noxious gas and smoke. Various attempts have been made to impart flame retardancy to PE including painting, enclosing the pipe with a metal jacket, and blending the PE with other materials. None of these teachings have been entirely satisfactory.

Because of the poor flame retardant characteristics of PE, it has now been suggested to chemically graft a coating with flame retardant properties onto the outer surface of the outer shell.

U.S. Pat. No. 6,783,865, owned by the assignee hereof, the description of which is hereby incorporated by reference in its entirety, discloses methods and compositions for grafting selected coatings onto PE, including HDPE and other PE-based polymers, to provide improved surface properties, including flame retardancy, ease of painting, scratch and abrasion resistance with a surface energy of more than 80 dynes/cm², and other improvements.

Although the teachings of the '865 patent provide a method of grafting fire retardant materials to the outer surface of the outer shell of pre-insulated pipes, the graft coating alone has not proven to be a satisfactory solution for pre-insulated pipes.

Even providing a graft coating of the type described in the '865 patent has not been entirely satisfactory due to a special problem that exists with respect to providing fire retardant properties to pre-insulated PE pipes. When pre-insulated pipes are exposed to flames and/or heat, the gas in the insulation material, such as polyurethane foam, begins to expand. Cell gasses in a 90% closed cell foam structure behind the HDPE outer shell start to expand as heat from a fire source begins to penetrate the outer shell. The expanding or ballooning of the cell gasses cannot be retained by the HDPE outer shell which has been weakened by the heat. The ballooning effect of the casing material increases as the temperature from the heat source rises. As the cell gasses balloon, the surface of the HDPE expands forcing the graft coating to thin as it expands along with the HDPE. The teachings of the '865 patent do not provide a graft coating with sufficient mechanical properties, such as strength or elasticity, to prevent the exposure of ungrafted HDPE to the fire due to expansion of the HDPE outer shell.

Known methods of preventing the damage to pipes from ballooning include incorporating threads in the pipes or outer shell pipes in order to resist the pressure from within the pipe. This method is expensive and must often be tailored to the specific casing diameter that fits the carrier pipe.

Thus, there remains a need for a fire retardant coating for a pre-insulated pipe with an HDPE outer shell capable of maintaining a low surface temperature, and possessing sufficient elasticity and strength for providing protection against the ballooning effect of the cell gasses of the insulating foam.

### SUMMARY OF THE INVENTION

Accordingly, the present invention provides for graft coated pre-insulated pipes with fire retardant properties and methods for their construction, wherein a graft coating including a graft solution and an expandable insulation material are applied to the outer surface of a pre-insulated pipe. The pre-insulated pipe includes an inner carrier pipe, an outer shell polyethylene pipe surrounding the carrier pipe, and an insulating foam between the carrier pipe and the outer shell pipe.

Broadly, the invention provides for a graft coated pre-insulated pipe with fire retardant properties that includes an outer shell formed of one or more types of PE, wherein the graft coating is covalently bonded to the outer surface of the outer shell, and the coating includes a graft solution and an expandable insulation material. In a preferred embodiment, the graft coating also includes a fiber mesh. The graft solution includes a non-polyethylene polymer or copolymer, such as a vinyl polymer, a urethane, an epoxy, a polysilicone and/or combinations thereof. In a preferred embodiment, the grafting solution also includes one or more fire retarding agents. The expandable insulation material maintains a low surface temperature for the underlying HDPE outer shell which prevents or mitigates the ballooning of the outer shell caused by expanding gasses, caused by the heat. The expandable insulation material in the graft coating may also be enhanced with material that reinforces its elasticity, which prevents the graft coating from forming gaps when the PE outer shell expands, thereby preventing the exposure of the outer shell to flames.

In one embodiment, the pre-insulated pipe includes an outer shell formed of a PE having a density, for example, ranging from about 0.930 g cm⁻³ to about 0.940 g cm³, or greater. The included polyethylene broadly has an average molecular weight ranging, e.g., from about 100,000 amu to at least 6×10⁶ amu.

Thus, the pre-insulated pipe is preferably manufactured prior to the application of the graft coating to the pre-insulated pipe. The pre-insulated pipe according to the invention includes, for example, straight pipe, bent pipe, a straight pipe joint, an elbowjoint, an end-cap, a heat-shrinkable joint, and combinations thereof. The graft coated pipe according to the invention also includes, for example, pipe with a single insulating layer between two concentric walls, and pipe with a plurality of concentric insulating layers, to name but a few types of pipe that will benefit from the graft coating compositions and methods of the invention.

The graft coating provides the pre-insulated pipe with a number of improved properties, including the ability to resist melting and burning for a time period ranging from about 1 to about 18 minutes. The graft coating also maintains a sufficiently low surface temperature on the pre-insulated pipe to prevent the foam insulation of the pre-insulated pipe from expanding and exposing the pipe to flames. The graft coating according to the invention also provides additional support to the outer shell of the pre-insulated pipe in resisting the expansion of the foam insulation but which will expand to some extent to prevent the graft coating from cracking due to the above-mentioned ballooning effect. Additionally, the graft coating of the present invention may be integrated into the production process of pre-insulated pipes in a non-disruptive manner, thereby providing a fast and inexpensive way to provide standard pre-insulated pipes with effective flame retardant properties. Furthermore, the graft coating of the present invention enables manufacturers to provide their already produced standard pre-insulated pipes with flame retardant properties.

The test used to confirm the improved properties is configured so that the pre-insulated pipe is exposed to a planar heated surface that is heated, e.g., by burning fuel (e.g., natural gas or propane), or electrical resistance, to a temperature ranging from about 800 to about 960 degrees C. The heating panel is a rectangle that according to different test methods measures about 25×51 cm and larger, and the graft coated pre-insulated pipe that is tested is positioned in accordance with different test methods such as ASTM E 84 or IMO 653.

Further, the graft coating provides the pre-insulated pipe with an improved surface energy allowing for post manufacture painting, coating, marking and adhesive application to the grafted surface. The graft coated pre-insulated pipe according to the invention has a surface energy ranging from about 56 to about 80 dynes/cm², or higher.

Processes for applying the graft coating to polyethylene substrates are also provided by the invention. One process according to the invention is a method of preparing a graft coated pre-insulated pipe with fire retardant properties by covalently grafting a heat resistant coating onto the pre-insulated pipe by:

(a) applying a graft solution to the exterior surface of the outer shell of the pre-insulated pipe, wherein the graft solution includes a monomer or prepolymer, a metal ion graft initiator, a peroxide catalyst, and a polymerization promoter reactive with the monomer or prepolymer;

(b) applying an expandable insulation material, e.g. expandable graphite, to the exterior of the outer shell pipe while the previously applied graft solution is still wet; and

(c) curing the applied composition.

In a preferred embodiment, the solution of step (a) also includes a flame retardant material, such as chlorinated phosphate esters, melamine derivatives, oligomeric phosphate esters, bromoaryl ether/phosphate product, phosphorus-based flame retardants, and phosphonates and a compatible solvent or solvents. In another embodiment, the flame retardant material may be applied to the pre-insulated pipe separately.

In a preferred embodiment, the solution of step (a) also includes adding expandable insulation material, such as expandable graphite. In another embodiment, the expandable insulation material may be applied to the pre-insulated pipe separately.

In a preferred embodiment, the method of preparing a graft coated pre-insulated pipe with fire retardant properties also includes applying a fiber mesh to the outer surface of the outer shell of the pre-insulated pipe after applying the graft solution and the expandable insulation material. Graft solution and the expandable insulation material may also be applied to the fiber mesh before or after the fiber mesh is applied to the pre-insulated pipe. This application of graft solution and expandable insulation material to the fiber mesh may be in lieu of or in addition to applying the graft solution and the expandable insulation material to the pre-insulated pipe.

Optionally, the graft solution of step (a) may also include a pre-formed polymer, suitable to be grafted to the activated pre-insulated pipe surface, alone and/or in combination with one or more of the monomer/prepolymers. The polymer is, e.g., a vinyl polymer, a urethane, an epoxy, a polysilicone, and/or combinations thereof, suitable to be grafted to the PE surface. In a further optional embodiment, the graft solution also includes a colorant such as a dye or pigment, and/or a fire retardant agent.

In another embodiment of the invention, the graft solution is first prepared without the polymerization promoter, and the process further comprises the step of mixing the polymerization promoter with the graft solution prior to application of the graft solution to the pre-insulated pipe, which allows for a longer storage period for the prepared graft solution.

The monomer or prepolymer is a vinyl monomer, a urethane monomer, an epoxy monomer and/or a silicon-based monomer or prepolymer. The graft initiator is an effective amount of a metal ion, e.g., present in a concentration ranging from about 0.01 to about 1.0%, by weight. For example the metal ion is an ion of iron, silver, cobalt, copper, cerium and/or combinations thereof. The catalyst is a peroxide present in the liquid composition in a concentration ranging from about 0.1 to about 5% by weight and includes, e.g., benzoyl peroxide, methyl ethyl ketone peroxide, 1-butyl hydroperoxide and/or combinations thereof. In one embodiment the polymerization promoter is present in a concentration effective to react with, and crosslink, the monomer or prepolymer. The polymerization promoter is a polyfunctional aziridine liquid crosslinker.

In yet a further embodiment, the outer shell to which the graft coating is applied is a polyethylene having a density ranging, for example, from about 0.930 g cm³ to about 0.940 g cm³, or greater.

Optionally, the applied composition is self-curing, and/or cured by heating, and/or by exposure to ambient atmospheric moisture, e.g., when the monomer or prepolymer is a moisture curing (e.g., a moisture curing urethane). Depending upon the required conditions, the applied graft coating is cured at room temperature, e.g., for a period of time as long as 6 days, or by the application of heat, e.g., ranging up to about 95° C. degrees F. for a time period of as little as 30 minutes.

In any of the previously mentioned embodiments, the graft solution is applied to the pre-insulated pipe by a method selected from the group consisting of brushing, dipping, spraying and/or combinations thereof.

In yet a still further composition, the invention provides for a graft coated pre-insulated pipe with fire retardant properties, prepared by the process of the above described methods.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1A is a schematic cross-section of a conventional pre-insulated pipe to which the present invention can be applied;

FIG. 1B is a schematic cross-section of a pre-insulated pipe having a graft coating in which ballooning has resulted in a breach of the graft coating;

FIG. 2 is a schematic cross-section of one embodiment of a pre-insulated pipe with a graft coating, according to the present invention;

FIG. 3 is a schematic cross-section of another embodiment of a pre-insulated pipe with a graft coating that includes a fiber mesh, according to the present invention;

FIG. 4A is a schematic cross-section showing the application of a graft coating to a fiber mesh with applied graft coating, according to the present invention;

FIG. 4B is a schematic cross-section of one embodiment of the graft coating including a fiber mesh, according to the present invention; and

FIG. 5 is a schematic cross-section of a pre-insulated pipe with a graft coating that includes a fine fiber mesh.

### DETAILED DESCRIPTION OF THE INVENTION

The invention provides a graft coated pre-insulated pipe with fire retardant properties and methods for chemically bonding or grafting a coating of polymer or polymers containing expandable insulation material to the outer surface of a pre-insulated pipe.

Outer Shell of Pre-insulated Pipes: Polyethylenes and Copolymers

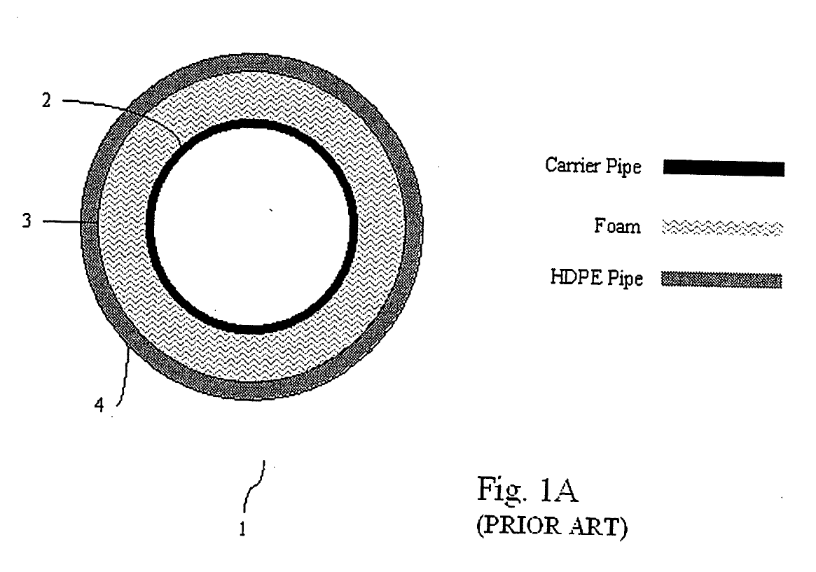

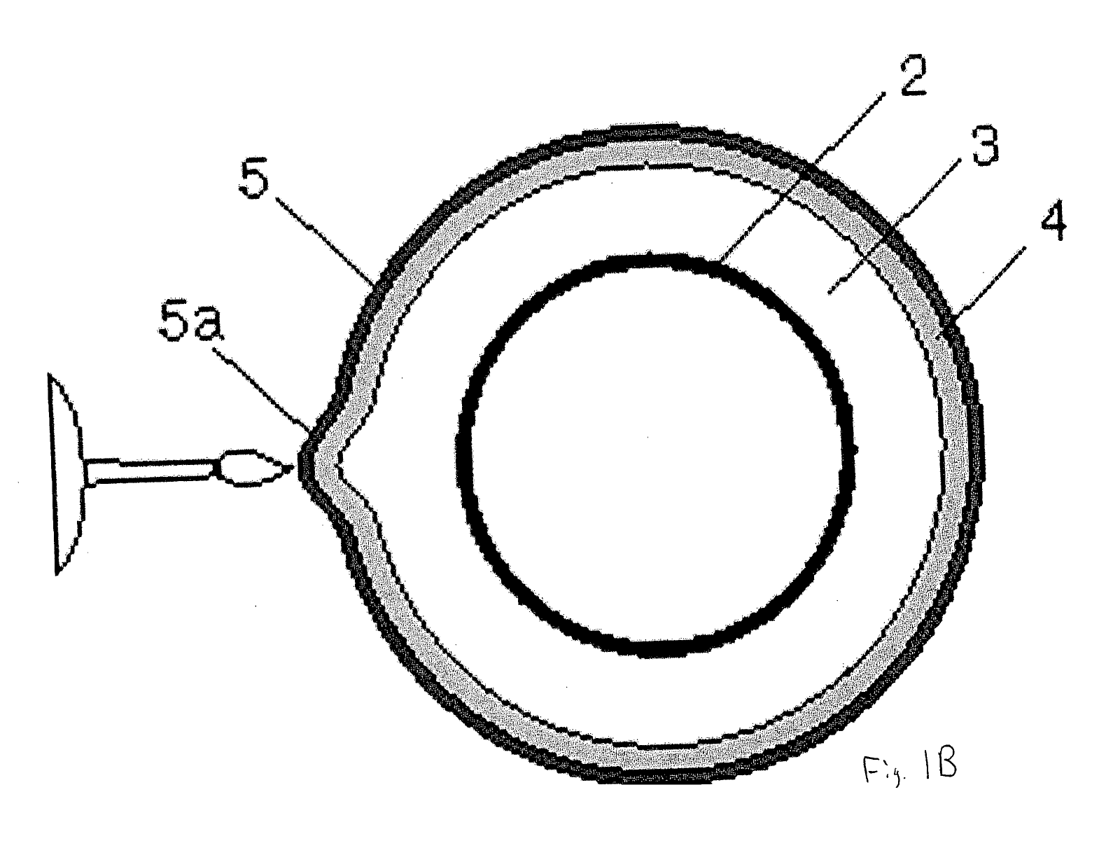

Referring now to the drawings wherein like reference characters designate identical or corresponding parts throughout the several views, and more particularly to FIG. 1A, an example of a pre-insulated pipe is generally designated 1. The pre-insulated pipe 1 is a standard pre-insulated pipe that is readily constructed to include an inner carrier pipe 2, an insulating foam layer 3, e.g. formed of a hard polyurethane, and an outer shell or jacket 4 of PE, such as HDPE.

Pre-insulated pipes 1 include pipes manufactured with one or more insulating layers 3. Preferably, there are one or two insulating layers, although the artisan will readily appreciate that additional insulating layers are readily added when desired. Such a pipe can optionally include additional art-known technical features, such as a tracer pipe embedded within the polyurethane foam insulation.

The pre-insulated pipe 1 discussed in the present invention includes any pre-insulated pipe with an outer shell 4 that is comprised of any PE or PE-based polymer or copolymer. The PE outer shell 4 preferably has a diameter of 66 mm to 1600 mm and a cross-section of 1.0 mm to 35.0 mm. Reference to “polyethylene” or “PE” herein should be understood to include all grades of polyethylene and/or mixtures of PE grades, unless otherwise specified. The PE can comprise more than 75% by weight of non-polyethylene materials. Alternatively, the PE is blended or mixed, or formed as a copolymer, in combination with other polymers, and/or derivatives of polyethylene.

Painting or grafting a fire retardant on a pre-insulated pipe through methods known in the art has not provided pre-insulated pipes with sufficient flame retardancy. Referring to FIG. 1B, when a pre-insulated pipe 1 is exposed to flames the gasses in the closed cells of the insulating foam 3 begin to expand. The expansion of the gasses, also known as ballooning, can cause the PE outer shell 4 to expand and warp. The expansion of the PE outer shell 4 is exacerbated by the weakening of the PE at higher temperatures. PE begins to soften at around 85° to 95° C. As the PE outer shell expands, a coating of flame retardants 5 grafted or painted onto the outer shell 4 begins to thin as it expands with the PE outer shell reducing its flame retardant properties. Eventually, the coating is stretched so thin that breaches or gaps form at point 5a in the flame retardant coating 5 . The gaps in the coating 5 allow the PE outer shell 4 to be exposed to the flames, leading to burning drops and ultimately to the destruction of the pre-insulated pipe 1.

The graft coated pre-insulated pipe with fire retardant properties mixed with expandable insulation material of the present invention resists the damage from the ballooning effect by maintaining a low surface temperature on the pre-insulated pipe and, optionally, strengthening and supporting the outer shell of the pre-insulated pipe. The low surface temperature prevents or mitigates the ballooning of the PE outer shell 4. In a preferred embodiment, additional materials are added to the graft coating that improve the elasticity of the graft coating thereby prolonging the flame retardant and anti-ballooning effects of the graft coating.

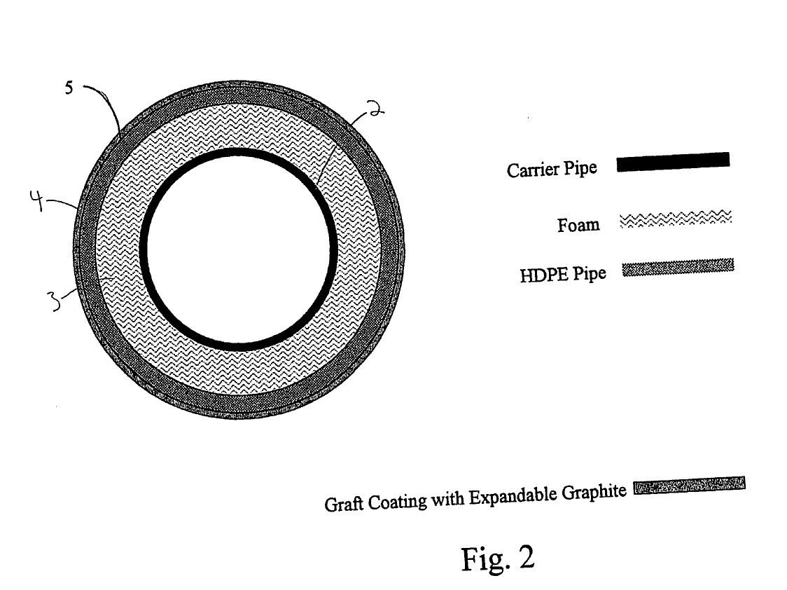

Referring now to FIG. 2, a graft coating 6 is applied to the outer shell 4 of the pre-insulated pipe 1. As noted supra, the grafting processes of the invention can be applied to an outer shell 4 formed of all grades of polyethylene, including derivatives, and mixtures and PE-copolymers formed with other types of polymer. Preferably the polyethylene outer shell 4 to be graft coated is a high density polyethylene or HDPE (>0.940 g cm⁻³>0.0338 lb/in³, MW approx. 100000);

Other embodiments of graft coated PE outer shell 4 are formed from high density, high molecular weight polyethylene or HDPE-HWM (MW ranges from about 200,000 to about 500,000);

Further embodiments of graft coated PE outer shell 4 are formed from HDPE-UHWM: High density, Ultra high molecular weight polyethylene (>0.940 g cm³>0.0338 lb/in³, MW>106 to 6×10⁶);

Further still, there are useful embodiments of the invention that are formed by graft coating an outer shell of PE-LD: Low density polyethylene (<0.930 g cm⁻³<0.0334 lb/in³), as well as PE-LLD: Linear low density polyethylene (0.918 to 0.935 g cm³/0.0334 to 0.0339 lb/in³); PE-MD: medium density polyethylene (0.930 to 0.940 g cm⁻³/0.0334 to 0.0338 lb/in³); and combinations and blends of the above described grades of PE.

In further still embodiments of the invention, mixtures and blends of the above described PE outer shell 4 with other polymers are also contemplated to be used as the outer shell 4 of a pre-insulated pipe and advantageously graft coated according to the invention. For example, a pre-insulated pipe's outer shell 4 may be manufactured from two different types of polymer. A first type of outer shell is a mix of HDPE and PE-MD, and a second type is a mix of ethylene/vinyl acetate (“EVA”) and PE-LD. Both types of PE, as well as other types, including polyethylene modified with flexible butyl-based rubber or polymer, are readily graft coated.

Of course, the artisan will appreciate that any other art-known types and grades of polyethylene-based materials not mentioned above will also benefit from grafting by the methods and compositions of the invention.

The inner carrier pipe 2 is constructed of a material suitable for the intended purpose, and can comprise steel, copper, brass, or other art-known alloy, any of the various PE compositions mentioned supra, any commercially available epoxy fiberglass and/or polyvinyl polymer pipe, to name but a few possibilities. Where desired, when the inner carrier pipe 2 comprises PE, the inner surface can optionally be coated with a graft coating according to the invention, to enhance the properties of the carrier pipe lining and to provide, for example, improved resistance to heat, solvent penetration, and microbial contamination, to name but a few ways that the inner surface of PE-based carrier pipe can be enhanced.

In a further embodiment, a multi-layer pre-insulated pipe can include one or more additional insulating layers, comprising the polyurethane foam 3 found in the first layer, and/or optionally the second layer is manufactured from different insulation materials, including heat resistant fibrous materials such as, mineral wool and/or glass wool, or any other art-known insulating material.

Flame retardation in PE-based pre-insulated pipes is important, for example, in industries that require transportation of volatile and/or flammable liquids such as fuels. Other pre-insulated pipes comprised of PE that benefit from improved surface properties and reduced flammability include those for transporting food oils, paints, solvents, cleaning agents, and the like.

Graft Coated Pre-insulated Pipe and Method of Preparing

Without meaning to be bound by any theory or hypothesis as to any proposed mechanism underlying the grafting reaction of the inventive process, the grafting reaction is believed to take place by means of a chain polymerization. This type of polymerization reaction, also referred to in the art as a “backbiting” reaction, consists of initiation and propagation reactions. Essentially, a graft initiator is contacted with the surface to be treated, e.g., an outer shell of a pre-insulated pipe formed in whole, or in part, of PE. It is believed that the graft initiator removes a hydrogen from the PE surface, and thereby induces radical formation in the polyethylene substrate. The radicals thus formed attack nearby carbon bonds, breaking the polyethylene chain(s). Once the outer shell pipe's surface has been activated, selected polymers are linked to the outer shell pipe and/or selected monomers react to extend graft polymer chains onto the outer shell surface at the activated break points. Further details concerning the inventive graft coatings and methods of making these coatings, are discussed below.

Referring again to FIG. 2, the graft coated pre-insulated pipe of the present invention includes a pre-insulated pipe 1 with a graft coating 6 applied to the exterior of the outer shell 4. The graft coating 6 is composed of a graft solution and an expandable insulation material. The mechanism and the reactions of the graft solution, as well as its composition, is discussed below.

Grafting Mechanisms and Reactions

The graft reaction can be better understood by considering the following steps (1a) through (3), wherein PE or—[CH²—CH₂]ₙ—is used to form the outer shell (“S”) of a pre-insulated pipe the graft initiator is GI* and R′ is the residue of the polyethylene chain. x is a unit of vinyl monomer. The selection of x governs the property or properties that are obtained. Optionally, a mixture of monomers are employed, and more than one property of the PE outer shell can be modified or enhanced in a single processing step.

In step (1) the GI* induces radical formation (“S*”) in the polyethylene outer shell (1a).

Alternatively, the GI* activates reactive prepolymers or polymers (“P”) in the reaction medium, to P*(1b) that in turn directly grafts to the HDP (1c).
S-H—GI*→S*+H⁺⁺GI (1a)
GI*+P→P*+GI (1b)
S-H—P*→S—P (1c)

When the reaction proceeds according to step (1a), initiation occurs as shown by step (2) below. 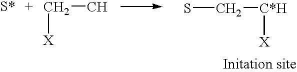
In step (3), chain propagation occurs, and continues.

(3) Chain Propagation 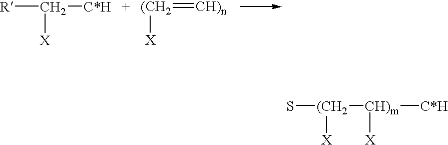
The graft initiator is optionally regenerated by reaction (4), as follows.
ROOH+GI→RO*+OH¹'+GI* peroxide (4)
The process may be terminated by radical combination as shown in reactions (5) and (6) 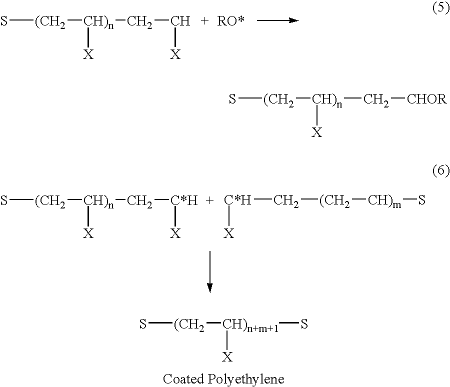
(Wherein, n and m are integers defining subunit number, and can be the same or different.

Thus, when the reaction proceeds from step (1a) through steps (2) and (3), the new polymer structure forms at the initiation site and the chain is lengthened from that point until the reaction is terminated. When the reaction proceeds from steps (1b) and (1c), a preformed reactive polymer is linked directly with the PE surface. Both alternative reactions provide a coated polyethylene material that possess all the desirable properties of the selected grafted polymer coating.

Methods and Solutions for Grafting

As exemplified below, the graft coating includes a grafting solution and an expandable insulation material. The grafting solution is applied to a pre-insulated pipe with a n outer shell formed of PE, exemplified as HDPE, by any available art-known method, including, e.g., brushing, spraying, dipping, spin coating, vapor deposition, and the like. The viscosity of the grafting solution is adjusted as needed, so that, for example, it is sufficiently viscous for application by dipping or brushing, without significant dripping or running of the applied solution, or sufficiently thin when optionally sprayed onto the surface to be treated.

For convenience, the grafting solution is optionally prepared in two parts: Part A and Part B.

Formulation of Part A

Part A of the grafting solution is prepared in a solvent compatible with the reagents selected for the grafting. Solvents are selected depending on the prepolymer and/or monomers employed, and can include polar solvents such as water, water soluble alcohols, ethers, esters, ketones, and derivatives and mixtures thereof, and nonpolar solvents such as organic solvents, e.g., aromatic solvents such as benzene and its derivatives, alkanes and/or alkenes and their derivatives, halogenated organic solvents, other readily available solvents.

Graft initiators are preferably metal ions including, for example, iron, silver, cobalt, copper, cerium and others. More preferably, as exemplified herein, silver ion is employed. The graft initiators are preferably employed at a concentration ranging from about 0.01 to about 1.0%, and more preferably from about 0.001 to about 0.1% by weight, relative to the weight of prepolymer or monomer(s) present.

Catalysts are preferably peroxides, including, for example, hydrogen peroxide and any organic peroxide, such as, e.g., benzoyl peroxide, methyl ethyl ketone peroxide, 1-butyl hydroperoxide and derivatives and combinations thereof. The catalysts are preferably employed in a concentration ranging from about 0.1 to about 5%, or greater. More preferably, the catalysts are employed in a concentration ranging from about 0.05 to about 1.0% (by wt relative to the solution weight).

Monomers or prepolymers include, for example, organic-based monomers, silicon-based monomers, and/or combinations thereof. Organic-based monomers useful for grafting surfaces comprising PE preferably include urethane precursors. Urethane precursors include water-dispersed polyurethane monomers, e.g., NeoRez.™.R-9679 (Avecia, Inc., Charlotte, N.C.). Other water-dispersed prepolymers include epoxy monomers, e.g., preferably including the epoxy monomer available as Epi-Rez.™.(Shell Chemical Co., Parsippany, N.J.).

Aliphatic moisture-curable urethanes are also employed, e.g., the Spenlite.™.M27-X-63 and/or the less viscous M22-X-40 (Reichhold Chemical, Inc., Research Triangle Park, N.C.), and D.R.R. G84 EK 40 epoxy resin (Dow Chemical) and/or combinations thereof.

Aromatic moisture curing urethanes include, for example, the Spenkel.™.M21-X-40, M21 -X-Z40LM, M23-X-56, M37-A6X-42, M67-160, M26-X-64and M86-A6X-60 and/or combinations thereof (Reichhold Chemical, Inc., Research Triangle Park, N.C.).

Aromatic urethane prepolymers include, for example, the Spenkel.™.P49-A60, P82-K4-75, and/or combinations thereof (Reichhold Chemical, Inc., Research Triangle Park, N.C.). Other art-known epoxy resins/prepolymers are also readily employed. These include, for example, epoxy prepolymer Araldite GZ 488-40, epoxy resin (Ciba Geigy Corp.).

Silicon-based monomers useful for grafting surfaces comprising PE preferably include silane prepolymers. Readily available silane monomers include organic silanes such as, vinyl alkyl-ethoxysilanes, e.g., vinyl triethoxy silane and vinyl trimethoxy silane monomers, e.g., SiV 9112.0 and SiV 9220.0, respectively, from Galest, Inc., Tullytown, Pa.), to name but a few. Combinations of any of the foregoing monomers/prepolymers may optionally be employed.

In one preferred embodiment, vinyl and epoxy functional silanes, such as the vinyl triethoxy silane and vinyl trimethoxy silane monomers described supra, are added to the grafting solution in order to provide improved paintability and scratch resistance to the outer shell 4. Such an improved surface allows the pre-insulated pipe to be readily painted or marked in any color or treated with any other useful adhesives or coatings after manufacture. With these improved surface properties, the pre-insulated pipe can be easily color-coded after manufacture, and/or marked with letters, numbers and other indicia. In another preferred embodiment, the grafted articles can be readily fixed or affixed to other articles by means of adhesive or glue-type systems. In an optional preferred embodiment, grafting of the interior surface of, for example, a PE-based carrier pipe can allow post-manufacture application of art-known coatings that will reduce solvent penetration of the carrier pipe and/or retard microbial growth within a fluid-filled system of pipes, as needed.

In another preferred embodiment, additional components are optionally combined with the liquid composition. Such additional components include, e.g., one or more dyes or pigments that impart a heat-reflective property to the grafted coating, as well as with any other art-known components commonly added to paints and coatings. Such reflective colorants include, simply by way of example, finely divided metal powders, in a proportion sufficient to give the finished grafted coating a metallic and reflective appearance. Such metal powders, include, without limitation, aluminum, copper, brass, stainless steel, gold, chromium and /or any other suitable powdered material that will impart a heat reflective luster. Optionally, other reflective colorants are employed, separately or in combination with metallic powders. Such additional reflective colorants include, for example, powdered titanium dioxide, zinc oxide, and/or combinations thereof, in proportions that impart a reflective white appearance to the finished coating.

In a further preferred embodiment, suitable inorganic or organic dyes or pigments that impart a marking color that is not white or metallic are mixed into the grafting solution or covalently linked by art-known methods to one or more of the components of the liquid composition. These include colorants that impart red, green, orange, yellow, blue, violet and variations of these. Suitable colorants for this purpose include, simply by way of example, Tint Ayd EP or UL (Red), green yellow, and/or combinations thereof, that are commercially available, for example, from Daniel Products, Jersey City, N.J.). Additional such pigments or colorants include, e.g., zirconium oxide, zircon, zinc oxide, iron oxide, antimony oxide, and particularly weather resistant coated types of TiO₂. The pigments may also be blended with a suitable extender material which does not contribute significantly to hiding power. Suitable extenders include silica, baryte, calcium sulfate, magnesium silicate (talc), aluminum oxide, aluminum silicate, calcium silicate, calcium carbonate (mica), potassium aluminum silicate and other clays or clay-like materials. Where present, the pigments and extenders are normally present at a level of from about 0.1 to about 1.0 parts by weight per part by weight of the polymer components of the grafting composition, on a dry weight basis.

Further optional components of the liquid composition of the grafting solution and of the formed graft coating include, for example, anti-oxidants, UV absorbing compounds, and other stabilizers well known to the art in art-known proportions. The composition of this invention may also optionally include other ingredients in amounts which are commonly included in paint and lacquer formulations such, wetting agents, surfactants, bactericides, fungicides, mildew inhibitors, emulsifiers, suspending agents, flow control agents such as waxes or wax dispersions, level agents, thickening agents, pH control agents, slip agents such as silica or clay and the like.

In a still further embodiment, any of the above-described monomers, including, simply by way of example, dispersed polyurethane in combination with, e.g., epoxy prepolymers Epi-Rez.™.(Shell Chemical Co., Parsippany, N.J.), and NeoRez R9679.™ (Avecia, Inc., Charlotte, N.C.), are pre-linked with suitable colored dyes or pigments by art-known methods in order to provide a filly grafted and permanently colored surface to the treated PE substrates. Methods for linking dyes or pigments to these monomers are art-known. For example, the desired colorants and/or pigments are dissolved in monomers/prepolymer solution and then applied onto the desired substrate by any effective method (e.g., dipping or spraying), following by curing at, e.g., at about 65° C. for about 20 to about 30 minutes.

Prepolymers and/or monomers are preferably employed in the grafting solution in a concentration ranging from about 0.1 to about 50%, by weight, relative to the solution. More preferably, the prepolymers and/or monomers are employed in a concentration ranging from about 0.1 to about 20%, by weight, relative to the solution.

Thus, the desired reagents, e.g., prepolymer(s) and/or monomers, catalyst, graft initiator system and other ingredients of the composition are mixed in a container with a compatible solvent or solvents to form Part A.

In yet a still further embodiment, one or more flame retardant agent or agents are added to the formulation, e.g., are added to Part A. Any art-known flame-retardant composition that is compatible and miscible with the components and solvents of the formulation is optionally employed. For example, art-known organic or inorganic phosphorous-based flame retardants are readily employed. It is understood that the flame retardant agents may be applied to the outer shell 4 separately without being a component of the graft solution, as discussed below.

In particular, the flame retardant is a phosphorous-based flame retardant such as, for example, chlorinated phosphate esters, melamine derivatives, oligomeric phosphate esters, bromoaryl ether/phosphate product, and phosphonates. Exemplary flame retardants include, dimethyl methylphosphonat, diethyl-N,N-bis (2-hydroxyethyl) aminomethyl phosphonate, oligomeric chloroalkyl phosphate/phosphonate, tri (1,3-dichloroisopropyl) phosphate, oligomeric phosphonate, to name but a few.

These types of flame retarding agents, and others, are available, e.g., from Akzo Nobel Chemicals, Inc., Dobbs Ferry, N.Y., under the trade name of Fyrol .™. Additional flame retardants include, for example, isopropylated triaryl phosphates, aklyl aryl phosphates, t-buryl triaryl phosphates, triaryl phosphates and resorcinol diphenyl phosphate, which are available, e.g., from Akzo Nobel Chemicals, Inc., supra, under the trade names of Fyroflex.™.and Phosflex.™.' The Akzo Phosflex.™.products include, e.g., tributyl phosphate, isopropylated triphenyl phosphate ester, to name but a few.

As exemplified herein, dimethyl methylphosphonate, available as Fyrol.™.DMMP from Akzo Nobel Chemicals, Inc., is mixed into the formulation, alone and/or in combination with any other suitable flame retardant material. The following table summarizes the flame retardant additives available from Akso Nobel Chemical, Inc., by both generic and trade names, and is provided for the convenience of the reader, and is not intended to limit the scope of the invention in any way.

Inorganic Phosphates

| | |
|---|---|
| Fyrex ™ | diammonium and monoammonium phosphate salt |
| Flexible Fyrex ™ | diammonium and monoammonium phosphate salt |

Monomeric and Oligomeric Phosphonates

| | |
|---|---|
| Fyrol ™ DMMP | dimethyl methylphosphonate |
| Fyrol ™ 6 | diethyl N,N bis [2-hydroxyethyl] |
| | aminomethyl phosphonate |

Melamine Derivatives

| | |
|---|---|
| Fyrol ™ MC | melamine cyanurate |
| Fyrol ™ MP | melamine phosphate |

Bromoaryl Ether/Phosphate Product

| | |
|---|---|
| Fyrol ™ PBR | pentobromodiphenyl oxide/phosphate ester |

Akzo Tradename

Chlorinated Phosphate Esters

| | |
|---|---|
| Fyrol ™ FR2 | tri (1,3-dichloroisopropyl) phosphate |
| Fyrol ™ CEF | tri (2-chloroethyl) phosphate |
| Fyrol ™ PCF | tri (2-chloroisopropyl) phosphate |
| Fyrol ™ 38 | tri [1,3-dichloroisopropyl] phosphate |

Oligomeric Phosphate Esters

| | |
|---|---|
| Fyrol ™ 25 | oligomeric chloroalkyl phosphate/phosphonate |
| Fyrol ™ 51 | oligomeric Phosphonates |
| Fyrol ™ AH | |
| Fyrol ™ 99 | oligomeric chloroalkyl phosphate |

Flame retardant(s) are added to Part A in a proportion that enhances the flame retardant properties of the graft coating without impairing other desirable properties as described and defined herein. Thus, based on the foregoing, the artisan will appreciate what amounts/proportions of flame retardant to add to Part A. Simply by way of example, the flame retardant component(s) is added to Part A in a proportion of about 0.1 wt percent to about 10 wt percent. More particularly, the flame retardant is added to Part A in a proportion ranging from about 0.5 wt percent to about 5 wt percent. Preferably, when the flame retardant is, e.g., Fyrol.™.DMPP, it is added in a proportion ranging from about 0.5 wt percent to about 3 wt percent, or more.

The pH of the formulated liquid composition should preferably be in the range of from about 6-8 , and appropriate amounts of a suitable acid, e.g., phosphoric or acetic acids or a base, e.g. composition over periods of storage. Suitable crosslinking compounds include any art-known crosslinkers that will react with, and enhance crosslinking of the monomers or prepolymers employed for the grafting process. Such a polymerization promoter is particularly desired where the polymeric component contains functional groups which are capable of undergoing ionic condensation reactions, e.g., carboxy, hydroxy or epoxy.

Suitable polymerization promoters or crosslinking agents include melamine based amino resins such as hexamethoxymethylmelamine, benzoguanamine resins, urea formaldehyde resins, glycoluryl-based resins and like materials. Preferred crosslinking agents are those which are active at ambient temperatures, i.e., from about 20 to about 30° C. and include epoxy silanes such as gamma glycidoxypropyltrimethoxy silane, beta-(3,4-epoxycyclohexyl) ethyltrimethoxy silane and polyfunctional aziridines, In particular, the selected crosslinker is reactive with prepolymer or polymer carboxyl groups.

The crosslinker exemplified herein is a polyfunctional aziridine liquid crosslinker, such as, for example, 1-aziridinepropanoic acid, 2-methl-, 2 ethyl-2-(3-(2-methyl-1-azirindinyl)-1-oxypropoxy) methyl)-1,3-propandiyl ester marketed by Zeneca Resin, Wilmington, Mass., under the trade name Crosslinker CX-100.™. This is a trifunctional material with an equivalent weight of 156, that is used to crosslink monomers, prepolymers and/or polymers with reactive carboxyl functionality, in both water-based and organic solvent-based systems.

Optionally, other art-known components are provided in Part B, include, simply by way of example, hardeners stabilizers and the like. For those embodiments comprising epoxy monomers or precursors, hardener or curing agents include, e.g., hardeners or curing agents such as, for example, those comprising amidoamines, polyamides, cycloaliphatic amines and the like. Polyamine epoxy curing agents or hardeners, e.g., including those comprising trimethylhexamethylenediamine, are commercially available, for example, from Air Products and Chemicals, Inc. Allentown, Pa.)

The Grafting Solution and Process

Parts A and B are mixed in a suitable proportion, stirred to a uniform solution, and the resulting grafting solution may be applied directly to the PE outer shell 4 to be treated. The time necessary for the reaction to run to completion depends up the reaction temperature, the reagents employed and the desired properties of the grafted PE. Generally, after all the components of the graft coating are added, the solution is air dried onto the PE outer shell 4, and then cured by the application of heat for a time period ranging, e.g., from about 1 to about 4 hours, at a temperature ranging, e.., from about 100 to about 150 degrees F. When heat curing is undesirable, the coated pre-insulated pipe can optionally be allowed to cure at ambient temperature, e.g., 25-30 degrees C., for up to 6 or more days.

The expandable insulation material can either be added as a component of Part A of the grafting solution or it may be applied to the outer shell pipe 4 after the grafting solution has been applied, but while the grafting solution is still wet. Once the flame raises the temperature to the expansion temperature of the expandable insulation material, the expandable insulation material is initiated and begins to expand. The expansion of the expandable insulation material maintains the low temperature on the surface of the PE outer shell thereby preventing ballooning. The thicker the coating of expandable insulation material, the longer the graft coating can maintain a low surface temperature and protect the pipe.

The expandable insulation material is preferably expandable graphite with a particle size ranging from 0.01 mm to 2.0 mm. Preferably, the expandable graphite has a heat activation temperature between 120° C. and 250° C. The expandable graphite has an expansion volume of between 50 ml/gram and 500 ml/gram, preferably 250 ml/gram. The expandable insulation material provides the graft coating with insulation capacity and elasticity. In some cases, the expandable insulation material also provides the flame retardancy.

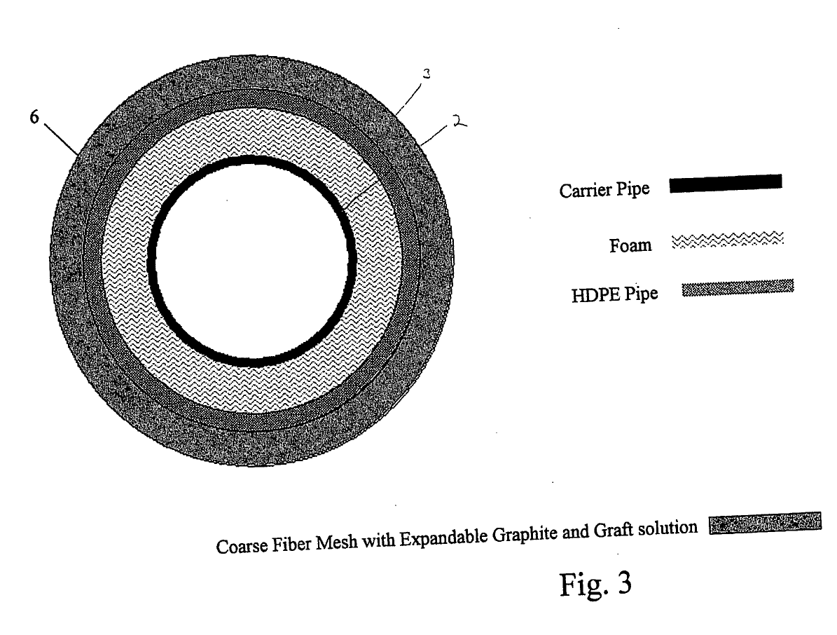

Referring now to FIG. 3, a preferred embodiment is shown in which the graft coating 6 also includes a polymer fiber mesh. The polymer fiber mesh has a melting point higher than that of the PE outer shell, preferably greater than 120° C., and a mesh size between 0.1 mm to 10 mm, preferably between 0.1 mm and 1.0 mm. The fiber mesh is formed from materials such as fiberglass, carbon, kevlar, or other materials capable of withstanding high temperatures. The fiber mesh strengthens and supports the PE outer shell 4 to resist the ballooning effect of the gasses caused by the heat. Additionally, the fiber mesh may provide some fire retardancy to the pre-insulated pipe and elasticity to the graft coating as well as diffusion properties that enhance the foam insulation properties.

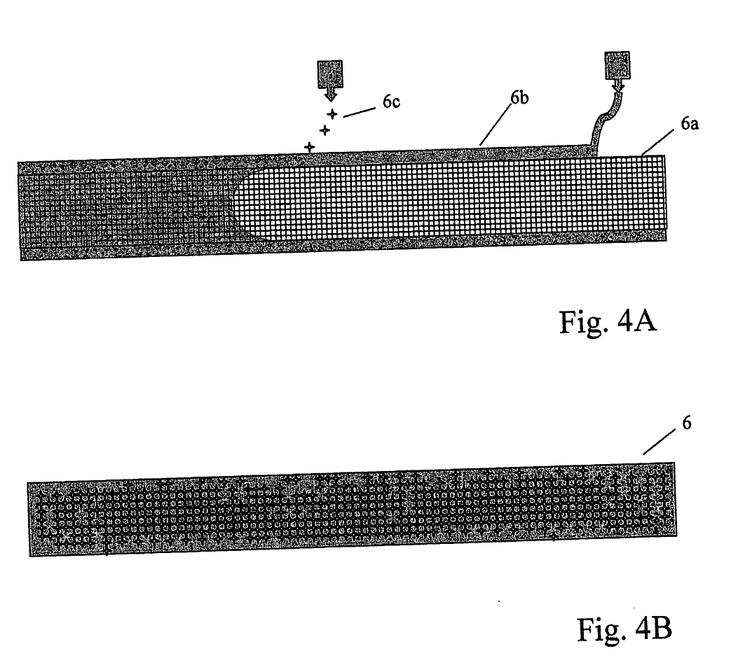

Referring to FIG. 4A, a preferred method of applying the graft coating to the pre-insulated pipe is by first applying the grafting solution 6b and the expandable insulation material 6c to both sides of a fiber mesh 6a. The grafting solution 6b and the expandable insulation material 6c permeate the fiber mesh 6a to form a graft coating 6 (FIG. 4B). The graft coating is then applied to the outer shell 4 (FIG. 3) of the pre-insulated pipe. It is understood that the grafting solution 6b and the expandable insulation material 6c may be applied to only one side of the fiber mesh 6a. In another embodiment, the grafting solution 6b is applied to both sides of the fiber mesh 6a, while the expandable insulation material 6c is only added to one side of the fiber mesh 6a, preferably the side of the fiber mesh that will come into contact with the outer shell 4. It is also understood that the grafting solution 6b and the expandable insulation material 6c may be applied directly onto the outer shell pipe 4 and the fiber mesh may then be applied to the outer shell pipe 4 while the grafting solution is still wet.

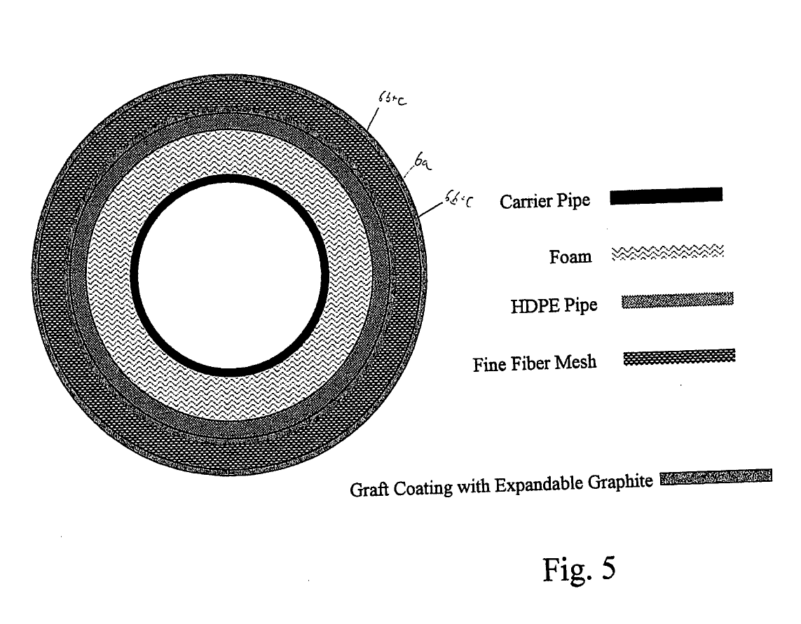

When using a fine polymer mesh, the grafting solution and the expandable insulation material may not be able to permeate the mesh. FIG. 5 shows a graft coating with a fine mesh of the present invention. The grafting solution and the expandable insulation material are applied to both sides of the fine mesh in order to form the graft coating 6.

The graft coating of the present invention provides many advantageous properties to the pre-insulated pipe of the present invention. Among others, the graft coating maintains a low surface temperature for the pre-insulated pipe. The low surface temperature prevents or slows the ballooning of the pre-insulated pipe's insulation when the pre-insulated pipe is exposed to heat or flames. Additionally, the graft coating provides additional support to the outer shell of the pipe in order to prevent the outer shell from warping or cracking. The graft coating may also contain materials that provide elasticity to prevent cracks and gaps from developing in the flame retardant graft coating upon expansion of the pre-insulated pipe due to expansion of the gasses in the cells of the foam insulation when subjected to heat. Both the expandable insulation material and the grafting solution are required to prevent damage to the pre-insulated pipe when it is exposed to heat or flames.

Confirming the Properties of the Grafted Surface

The graft coatings were also tested for their ability to resist melting and catching fire for a time period, by exposure to a standardized source of intense radiant heat, as described in greater detail in the Examples, infra. Surface energy was tested using standardized wet-ability inks, described as follows.

Surface Energy Testing

A number of art-known methods are available for determining the improvement in adhesion of paints, cements, adhesives and the like to surfaces. The graft coated surfaces of PE samples were tested for their surface energy by a standardized commercial test of surface wet-ability using inks of known surface tension. The adhesion and/or paintability properties of the grafted surfaces depend upon the surface energy. A commercially available wet-ability ink is the Corona-plus Pro-Dyn Test Ink.™. (Vetaphone Company, Denmark). The test inks are formulated in standard felt-tipped pens, with inks that are rated by their surface tension in dynes/cm². If a surface is marked and the line of ink breaks up into small droplets (reticulates) within 3 seconds, then the surface has a surface energy lower than the surface tension rating of the ink. In essence, if the surface can be wet by the ink, the surface energy of the treated surface (e.g., the tested graft coating) is higher than the surface tension rating of the ink, in dynes/cm².

These test inks are marketed in 2-dyne/cm² increments, so that the surface energy of the grafted coatings is readily determined, and the graft coated sample articles produced by the following examples have been shown to have a surface energy of at least 56 dynes/cm², which is within the limits of the testing reagents available at the time of testing. Higher surface energy results, e.g., up to 80 dynes/cm², and greater, are expected to be confirmed with the availability of wet-ability testing reagents of greater surface tension limits.

Although the invention has been described in detail herein, it should be understood that the invention is not limited to the embodiment herein disclosed. Various changes, substitutions, and modifications may be made thereto by those skilled in the art without departing from the spirit or scope of the invention as described and defined by the appended claims.

I claim:

1. A method of preparing a graft coated pre-insulated pipe with fire retardant properties, said pre-insulated pipe comprising an inner carrying pipe; an outer shell polyethylene pipe surrounding said carrier pipe; and an insulating foam between said carrier pipe and said outer shell pipe, comprising the steps of:
applying a graft solution to the exterior of said pre-insulated pipe;
wherein said graft solution comprises a monomer or prepolymer, a metal ion graft initiator, a peroxide catalyst, and a polymerization promoter reactive with said monomer or prepolymer; and
wherein said graft solution is prepared by a process comprising the steps of combining a Part A solution and a Part B solution prior to application to the pre-insulated pipe, wherein the Part A solution comprises:
(I) a monomer or prepolymer suitable for grafting to the pre-insulated pipe, in an amount ranging from 0.1 to about 50%, by weight of the graft coating, selected from the group consisting of water-dispersed epoxy monomers, aliphatic moisture-curable urethanes, aromatic urethane prepolymers, silane prepolymers, vinyl and epoxy functional silanes and combinations thereof;
(ii) a metal ion graft initiator in an amount ranging from about 0.01 to about 1.0% by weight, relative to the weight of prepolymer or monomer in the graft coating, selected from the group consisting of ions of silver, iron, silver, cobalt, copper and cerium; and
(iii) a peroxide catalyst in an amount ranging from about 0.1 to about 5%, selected from the group consisting of hydrogen peroxide, an organic peroxide, and combinations thereof;
wherein the Part B solution comprises a polymerization promoter;
applying expandable graphite to the exterior of said outer shell pipe while said graft coating is still wet; and
curing said graft coated pre-insulated pipe.

2. The method of claim 1, wherein said Part A solution of said graft solution further comprises a flame retardant in an amount ranging from about 0.1 wt percent to about 10 wt percent of the solution, selected from the group consisting of chlorinated phosphate esters, melamine derivatives, oligomeric phosphate esters, bromoaryl ether/phosphate product, and phosphonates and a compatible solvent or solvents.

3. The method of claim 1, further comprising the step of applying a flame retardant in an amount ranging from about 0.1 wt percent to about 10 wt percent of the solution, selected from the group consisting of chlorinated phosphate esters, melamine derivatives, oligomeric phosphate esters, bromoaryl ether/phosphate product, and phosphonates and a compatible solvent or solvents, prior to said step of curing said graft coated pre-insulated pipe.

4. The method of claim 2, wherein said step of applying expandable insulation material is achieved contemporaneously with said step of applying said graft solution by adding said expandable insulation material to said graft solution and applying said graft solution.

5. The method of claim 2, wherein said polymerization promoter is selected from the group consisting of a polyfunctional aziridine liquid crosslinker and an aromatic polyisocyanate, in a concentration effective to react with, and crosslink, said monomer or prepolymer.

6. The method of claim 2 wherein said expandable insulation material is expandable graphite.

7. The method of claim 2 wherein the monomer or prepolymer comprises an epoxy moiety, and the Part B solution further comprises at least one epoxy hardener or curing agent.

8. The method of claim 2, further comprising the step of applying a fiber mesh to the exterior of said pre-insulated pipe after said step of applying a graft solution, and before said step of curing said graft coated pre-insulated pipe.

9. The method of claim 6 wherein said expandable graphite has a particle size from 0.01 mm to 2 mm.

10. The method of claim 6 wherein said expandable graphite has an expansion volume of between 50 ml/gram and 500 ml/gram.

11. The method of claim 8 wherein said step of applying graft solution to said pre-insulated pipe is achieved contemporaneously with said step of adhering said fiber mesh to said pre-insulated pipe by applying graft solution to a first side of said fiber mesh and adhering said fiber mesh to said pre-insulated pipe such that said first side of said fiber mesh abuts the exterior of said pre-insulated pipe.

12. The method of claim 8 wherein said step of applying expandable insulation material to said pre-insulated pipe is achieved contemporaneously with said step of adhering said fiber mesh to said pre-insulated pipe by applying expandable graphite to a first side of said fiber mesh and adhering said fiber mesh to said pre-insulated pipe such that said first side of said fiber mesh abuts the exterior of said pre-insulated pipe.

13. The method of claim 8, further comprising the step of applying said graft solution a second side of said fiber mesh.

14. The method of claim 8 further comprising the step of applying expandable insulation material to a second side of said fiber mesh.

15. The method of claim 8 wherein said fiber mesh has a melting point of greater than 120° C.

16. The method of claim 8 wherein said fiber mesh has a thickness between 0.05 mm and 5 mm.

17. A graft coated pre-insulated pipe with fire retardant properties, said pre-insulated pipe comprising an inner carrying pipe; an outer shell polyethylene pipe surrounding said carrier pipe; and an insulating foam between said carrier pipe and said outer shell pipe; said graft coated pre-insulated pipe comprising,
a graft coating applied to the exterior of said pre-insulated pipe, wherein said graft coating comprises a graft solution and an expandable insulation material; wherein said graft solution comprises:
a combination of a Part A solution and a Part B solution, wherein the Part A solution comprises:
(I) a monomer or prepolymer suitable for grafting to the pre-insulated pipe and, in an amount ranging from 0.1 to about 50%, by weight of the graft coating, selected from the group consisting of water-dispersed epoxy monomers, aliphatic moisture-curable urethanes, aromatic urethane prepolymers, silane prepolymers, vinyl and epoxy functional silanes and combinations thereof;
(ii) a metal ion graft initiator in an amount ranging from about 0.01 to about 1.0% by weight, relative to the weight of prepolymer or monomer in the graft coating, selected from the group consisting of ions of silver, iron, silver, cobalt, copper and cerium; and
(iii) a peroxide catalyst in an amount ranging from about 0.1 to about 5%, selected from the group consisting of hydrogen peroxide, an organic peroxide, and combinations thereof;
wherein the Part B solution comprises a polymerization promoter.

18. A graft coated pre-insulated pipe of claim 17 wherein said graft coating further comprises a flame retardant in an amount ranging from about 0.1 wt percent to about 10 wt percent of the solution, selected from the group consisting of chlorinated phosphate esters, melamine derivatives, oligomeric phosphate esters, bromoaryl ether/phosphate product, and phosphonates and a compatible solvent or solvents.

19. A graft coated pre-insulated pipe of claim 17 wherein said graft coating further comprises a fiber mesh.

20. The graft coated pre-insulated pipe of claim 17, wherein said polymerization promoter is selected from the group consisting of a polyfunctional aziridine liquid crosslinker and an aromatic polyisocyanate, in a concentration effective to react with, and crosslink, said monomer or prepolymer.

21. The graft coated pre-insulated pipe of claim 17 wherein said expandable insulation material is expandable graphite.

22. The graft coated pre-insulated pipe of claim 17 wherein said monomer or prepolymer comprises an epoxy moiety, and said Part B solution further comprises at least one epoxy hardener or curing agent.

23. The graft coated pre-insulated pipe of claim 19 wherein said fiber mesh has a melting point of greater than 120° C.

24. The graft coated pre-insulated pipe of claim 19 wherein said fiber mesh has a thickness between 0.05 mm and 5 mm.

25. The graft coated pre-insulated pipe of claim 19 wherein said graft solution is applied to both sides of said fiber mesh.

26. The graft coated pre-insulated pipe of claim 19 wherein said expandable insulation material is applied to both sides of said fiber mesh.

27. The graft coated pre-insulated pipe of claim 21 wherein said expandable graphite has a particle size from 0.01 mm to 2 mm.

28. The graft coated pre-insulated pipe of claim 21 wherein said expandable graphite has an expansion volume of between 50 ml/gram and 500 ml/gram.

29. A graft coated pre-insulated pipe with fire retardant properties, said pre-insulated pipe comprising an inner carrying pipe; an outer shell polyethylene pipe surrounding said carrier pipe; and an insulating foam between said carrier pipe and said outer shell polyethylene pipe; wherein said graft coated pre-insulated pipe includes a graft coating applied to an outer surface of said outer shell polyethylene pipe, and wherein said graft coating comprises a graft solution and an expandable insulation material.

30. A graft coated pre-insulated pipe of claim 29 wherein said graft coating further comprises a flame retardant in an amount ranging from about 0.1 wt percent to about 10 wt percent of the solution, selected from the group consisting of chlorinated phosphate esters, melamine derivatives, oligomeric phosphate esters, bromoaryl ether/phosphate product, and phosphonates and a compatible solvent or solvents.

31. A graft coated pre-insulated pipe of claim 29 wherein said graft coating further comprises a fiber mesh.

32. The graft coated pre-insulated pipe of claim 29 wherein said expandable insulation material is expandable graphite.

33. The graft coated pre-insulated pipe of claim 31 wherein said fiber mesh has a melting point of greater than 120° C.

34. The graft coated pre-insulated pipe of claim 31 wherein said fiber mesh has a thickness between 0.05 mm and 5 mm.

35. The graft coated pre-insulated pipe of claim 31 wherein said graft solution is applied to both sides of said fiber mesh.

36. The graft coated pre-insulated pipe of claim 31 wherein said expandable insulation material is applied to both sides of said fiber mesh.

37. The graft coated pre-insulated pipe of claim 32 wherein said expandable graphite has a particle size from 0.01 mm to 2 mm.

38. The graft coated pre-insulated pipe of claim 32 wherein said expandable graphite has an expansion volume of between 50 ml/gram and 500 ml/gram.
